(19) United States
(12) Patent Application Publication
(10) Pub. No.: US 2016/0235263 A1
(43) Pub. Date: Aug. 18, 2016

(54) ELECTRICALLY HEATED TOILET SEAT AND METHOD FOR MANUFACTURING THE SAME

(71) Applicant: Zhihui Metal Industrial Co., Ltd., Shunde Foshan (CN)

(72) Inventors: Xingwen Du, Shunde Foshan (CN); Zhijian Du, Shunde Foshan (CN)

(21) Appl. No.: 15/009,869

(22) Filed: Jan. 29, 2016

(30) Foreign Application Priority Data
Feb. 13, 2015 (CN) 201510082242.4

(51) Int. Cl. A47K 13/30; H05B 3/00

(52) U.S. Cl. CPC A47K 13/305; H05B 3/00

(57) ABSTRACT

An electrically heated toilet seat includes a toilet seat and a heat conduction device disposed in the toilet seat. The toilet seat is composed of a toilet seat main body and an installation lid. At least one of the toilet seat main body and the installation lid is provided with a recessed configuration corresponding to the heat conduction device. The toilet seat main body and the installation lid are joined together to enclose the heat conduction device inside the toilet seat. The heat conduction device has a hollow configuration. The hollow configuration is provided with a detachable heating wire therein. The heating wire is connected with a power junction box. The electrically heated toilet seat can be heated evenly, and the heating wire can be maintained and replaced conveniently.

### CROSS-REFERENCE TO RELATED APPLICATION

This application claims priority to Chinese Patent Application Serial No. 201510082242.4, which was filed Feb. 13, 2015, and is incorporated herein by reference in its entirety.

### TECHNICAL FIELD

The present invention relates to a bathroom accessory, and more particularly to an electrically heated toilet seat and a method for manufacturing the same.

### BACKGROUND

Most toilet bases used in daily life are ceramic products, which make the user feel cold when used. Therefore, a toilet seat is provided on the toilet base. The toilet seat is made of a poor conductor material, such as resign, plastics, and so on, to enhance the comfort of use. Under the condition of lower temperature, the toilet seat made of the aforesaid materials is also cold. This makes the user uneasy. Thus, a heated toilet seat is developed on the market. The existing heated toilet seat is provided with a heating device inside the plastic toilet seat, or the heating device is pre-embedded inside the plastic toilet seat by integrally forming to become one-piece. On the one hand, heating solves the problem of a cold toilet seat, on the other hand, the integral configuration solves the problems of cleaning and leakage of electricity. During the process to form the integral toilet seat, the pre-embedded heating device may be deflected or damaged. As a result, the toilet seat won't be heated evenly or cannot be heated. In addition, the heating device integrally formed with the toilet seat is not replaceable. A toilet seat, as disclosed in Chinese patent pending application No. 201010220187.8, comprises a heating wire directly pre-embedded in the toilet seat. Specifically, the heating wire is disposed in the mold for injection molding to form an electrically heated toilet seat having a heating device therein. In the electrically heated toilet seat manufactured by this way, the heating wire is fixed inside the toilet seat, so it cannot be maintained and replaced. It is required to replace a whole toilet seat. This increases the maintenance cost. Besides, it is difficult to fix the heating wire when the toilet seat is formed to cause a malposition easily. When in use, the toilet seat may be heated unevenly and a partial portion of the toilet seat may be overheated. Accordingly, the inventor of the present invention has devoted himself based on his many years of practical experiences to solve these problems.

### SUMMARY

The present invention is to provide an electrically heated toilet seat to solve the problems of the prior art. The toilet seat can be heated evenly, having high yield and low failure rate. The heating wire of the toilet seat can be replaced quickly to lower the cost.

In order to achieve the aforesaid object, the electrically heated toilet seat of the present invention comprises a toilet seat and a heat conduction device disposed in the toilet seat. The toilet seat is composed of a toilet seat main body and an installation lid. At least one of the toilet seat main body and the installation lid is provided with a recessed configuration corresponding to the heat conduction device. The recessed configuration is disposed on the toilet seat main body only, or the recessed configuration is disposed on the installation lid only. The toilet seat main body and the installation lid are joined together to enclose the heat conduction device inside the toilet seat. The heat conduction device has a hollow configuration. The hollow configuration is provided with a detachable heating wire therein. The heating wire is connected with a power junction box. Through the heat conduction device of the aforesaid structure to conduct heat, the toil seat is heated quickly and evenly when electrified. In the aforesaid structure, the heating wire can be replaced conveniently. When the heating wire is damaged, the heating wire can be pulled out and replaced with a new one.

Preferably, the heat conduction device comprises a hollow metallic pipe, and the heating wire is disposed in the hollow metallic pipe. Preferably, the heat conduction device is composed of a metallic baseplate and a hollow metallic pipe fixed to the metallic baseplate, and the heating wire is disposed in the hollow metallic pipe. The metallic baseplate provides a support and positioning effect and increases heat conduction area, enabling the heat conduction device to be positioned inside the toilet seat without deflection. Larger superficial area is beneficial for heat conduction, such that the toilet seat can be heated quickly after electrified so as to prevent a partial portion of the toilet seat from being overheated. The hollow metallic pipe is adapted to secure the heating wire. The diameter of the hollow metallic pipe is larger than diameter of the heating wire. This is convenient for replacement of the heating wire. When the heating wire is damaged, the heating wire can be pulled out to be replaced with a new one. Compared to the traditional heating wire fixed in the toilet seat, the present invention can be maintained conveniently and is cost-effective.

Preferably, the hollow metallic pipe is located under the metallic baseplate, and the heating wire is guided out from one end of the hollow metallic pipe. Preferably, two ends of the hollow metallic pipe extend out of the metallic baseplate to form exposed end portions. This design is convenient to guide out and replace the heating wire. The length of the exposed end portion is 1-5 cm. In general, the metallic baseplate is disconnected at the rear end of the toilet seat to save the material. The two ends of the hollow metallic pipe are located at the rear end of the toilet seat.

Preferably, a bottom of the toilet seat is formed with an inner engaging trough, an outer engaging trough, and a raised portion between the inner engaging trough and the outer engaging trough. The installation lid is disposed on the raised portion. After the installation lid and the toilet seat main body are joined together, the heat conduction device is enclosed in the raised portion. The raised portion provides a space for the heat conduction device to be installed in the toilet seat. Single-stage molding technology is difficult, so the heat conduction device enclosed in the toilet seat by means of the single-stage molding technology may be deflected. As a result, the heat conduction device may be exposed, so that the toilet seat cannot be heated evenly and the appearance of the toilet seat is not pleasing to the eye. When in use, the toilet seat cannot provide better comfort. The installation configuration of the heat conduction device at the raised portion enables the toilet seat to be maintained more conveniently.

Preferably, a soft spacer is provided between the installation lid and the heat conduction device and another soft spacer is provided between joint surfaces of the installation lid and the toilet seat main body.

Preferably, the heat conduction device is disconnected at a front end of the toilet seat to be separated into two portions. The hollow metallic pipe of each portion has a U shape. The heating wire in the hollow metallic pipe of each portion is connected with the power junction box to form a separate circuit. When the user sits on the toilet seat, the front and rear ends of the toilet seat are seldom in contact with the user. Therefore, it is meaningless to heat the front and rear ends of the toilet seat. Some people are used to a toilet seat having a disconnected front end. This design is applied to the disconnected toilet seat. The heating wire in the U-shaped hollow metallic pipe is to constitute a circuit alone to heat the toilet seat after electrified.

Preferably, the heat conduction device comprises two hollow metallic pipes. Each of the two hollow metallic pipes is provided with the heating wire. The heating wire of each of the two hollow metallic pipes forms a closed circuit alone. The heating wires of the two hollow metallic pipes have different heating powers. In a cold climate, the temperature of the toilet seat is very lower when not in use. When the toilet seat is used, it needs a certain time to rise the lower temperature of the toilet seat to a comfortable temperature close to the human body's temperature. However, the user cannot wait for a long time to use the toilet seat. Therefore, the interior of the electrically heated toilet seat is provided with two or more heating wires with different heating powers. The heating wire with a lower power works for a long period, enabling the toilet seat to keep a temperature higher than a room temperature. Because the power is lower, the energy consumption is also lower. When the toilet seat is used, the heating wire with a larger power works, such that the temperature of the electrically heated toilet seat can be immediately risen to a comfortable temperature for use. This can shorten the preheating time of the electrically heated toilet seat greatly for the toilet seat to be used more conveniently.

A method for manufacturing an electrically heated toilet seat comprises the steps of:

1) preparing a heat conduction device: a metallic baseplate prefabricated according to the size of an electrically heated toilet seat being fixedly connected with a hollow metallic pipe to manufacture the heat conduction device;

2) preparing a toilet seat main body: the toilet seat main body having an installation recess being formed by thermal molding;

3) preparing an installation lid: the installation lid having a retaining recess being formed by thermal molding;

4) installing the heat conduction device: the heat conduction device in step 1) being placed in the installation recess of the toilet seat main body, the installation lid being to cover the installation recess of the toilet seat main body, the retaining recess being aligned with the installation recess so as to enclose the heat conduction device, the toilet seat main body and the installation lid being fixed by means of a screw, plastic ultrasonic welding, or a buckle to become an integral toilet seat; and

5) installing a heating wire: the heating wire being installed into the hollow metallic pipe, and the heating wire being guided out from one end of the hollow metallic pipe to connect with a power junction box.

It is necessary to explain that the installation lid is secured to the toilet seat main body through screws. The specification and fixing position of the screws depend on the shape and size of the installation lid and the toilet seat main body. The screws are arranged evenly to connect the installation lid and the toilet seat main body.

A toilet seat having a heat conduction device can be manufactured according to the foregoing method. The heat conduction device is provided with a replaceable heating wire therein. The method adopts two-stage molding. Afterward the toilet seat is assembled. The toilet seat manufactured by this method won't be affected with damp to cause a leakage of electricity. The toilet seat can be manufactured conveniently. The cost is lowered. It is safe for use.

Step 2) and step 3) can be changed in sequence.

In step 4), after the heat conduction device is placed into the installation recess, a stuffing is provided and filled between the heat conduction device and a side wall of the installation recess. When the installation lid is to cover the heat conduction device, a soft spacer is provided between joint surfaces of the installation lid and the toilet seat main body and another soft spacer is provided inside the retaining recess. When the heat conduction device is installed, the stuffing and the soft spacers are added. On the one hand, it is convenient to retain the heat conduction device so that the interior of the toilet seat won't shake, on the other hand, the heat from the heat conduction device can be transmitted to the toilet seat main body more easily through the stuffing. The airtightness of the junction of the installation lid and the toilet seat main body can be enhanced due to the soft pads, such that the toilet seat has a longer service life and can be used more comfortably.

In step 2), or step 3), or step 4), the material for thermal molding or the stuffing or the soft spacers is one of plastics, resin and rubber.

The toilet seat is made of at least one material of plastics, resin and rubber. The toilet seat is divided into an inner layer and an outer layer. Such a design can avoid the problem of malposition.

The voltage provided by the power junction box is generally below 36V. In general, the voltage is 12V and 24V. Preferably, the power junction box is sealed in the toilet seat in a detachable way. Alternatively, the power junction box can be disposed externally according to the demand. Selecting the above-mentioned voltage is mainly for security reasons. The power junction box is detachably sealed in the toilet seat to prevent an electrical leakage caused by water. Furthermore, the power junction box is provided with a temperature control unit. When the temperature exceeds the preset temperature, the power supply will be cut off automatically.

The electrically heated toilet seat of the present invention is safe for use and convenient for cleaning, and can be heated quickly. It is easy to install the heating wire and the heat conduction device. The heating wire inside the electrically heated toilet seat can be replaced conveniently for maintenance so as to lower the cost greatly and decrease the material.

### BRIEF DESCRIPTION OF THE DRAWINGS

FIG. 1 is a top view according to a first embodiment of the present invention;

FIG. 2 is a sectional view taken along line A-A1 of FIG. 1;

FIG. 3 is an enlarged view of circle C of FIG. 2;

FIG. 4 is a top view according to a second embodiment of the present invention;

FIG. 5 is a sectional view taken along line B-B1 of FIG. 4; and

FIG. 6 is a sectional view showing the toilet seat main body and the installation lid of an embodiment of the present invention.

### DESCRIPTION

Embodiments of the present invention will now be described, by way of example only, with reference to the accompanying drawings.

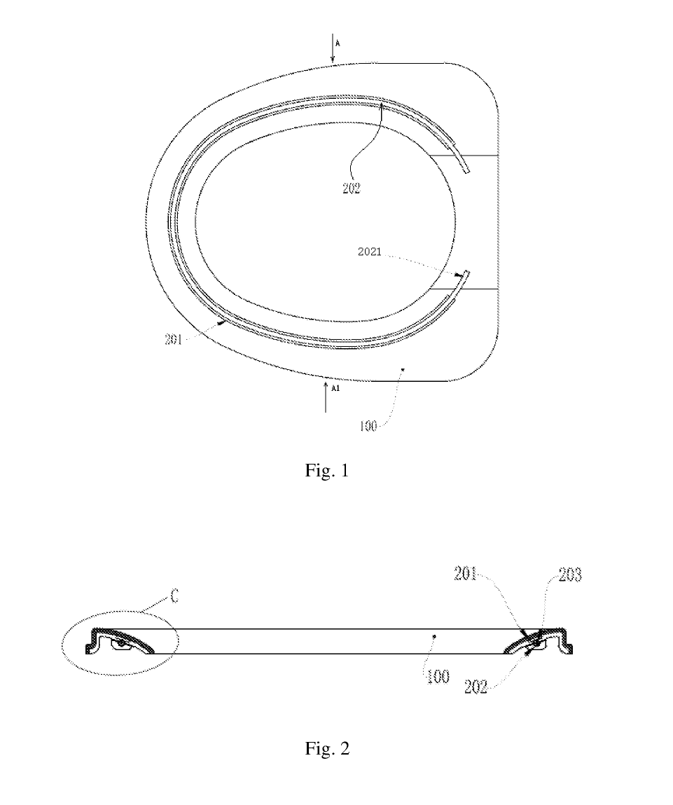

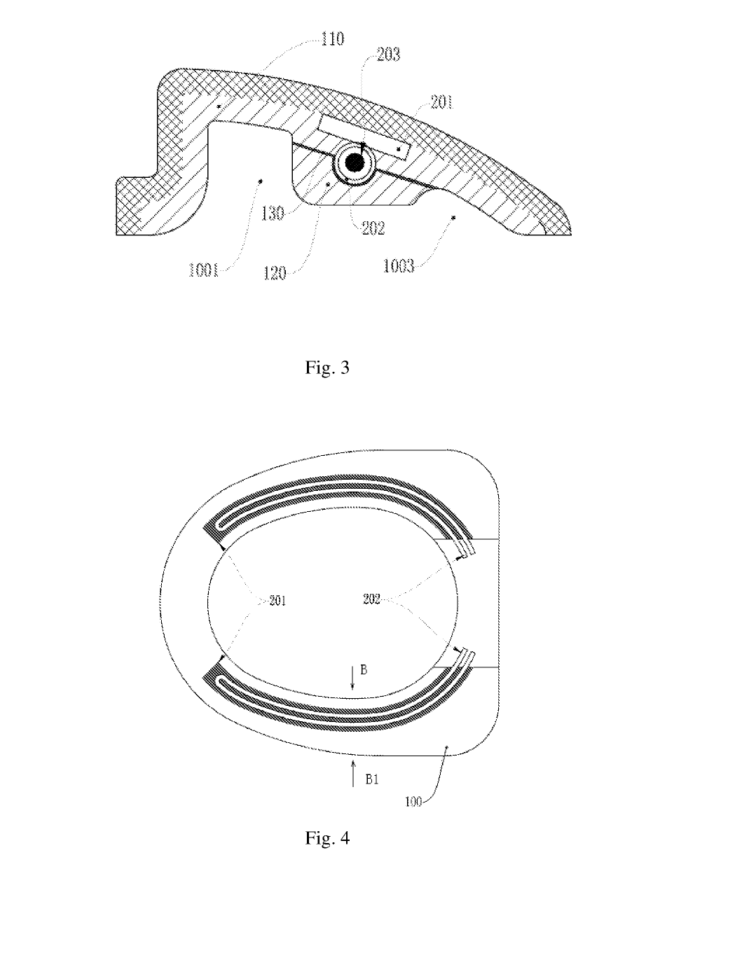

As shown in FIG. 1 through FIG. 3, an electrically heated toilet seat according to a first embodiment of the present invention comprises a toilet seat 100 and a heat conduction device disposed in the toilet seat. The heat conduction device comprises a metallic baseplate 201 and a hollow metallic pipe 202. The rear end of the toilet seat is disconnected. The hollow metallic pipe 202 is installed with a heating wire 203 therein. The heating wire is connected with a power junction box (not shown in the drawings). Through the heat conduction device of the aforesaid structure to conduct heat, the toil seat is heated quickly and evenly when electrified. In the aforesaid structure, the heating wire 203 can be replaced conveniently. When the heating wire 203 is damaged, the heating wire 203 can be pulled out and replaced with a new one.

According to the electrically heated toilet seat of this embodiment, the hollow metallic pipe 202 is located under the metallic baseplate 201. Two ends of the hollow metallic pipe 202 extend out of the metallic baseplate 201 to form exposed end portions 2021, and the heating wire 203 is guided out from the exposed end portions 2021 to connect with the power junction box. This design is convenient to guide out and replace the heating wire 203. The length of the exposed end portion 2021 is 3 cm. The internal diameter of the hollow metallic pipe 202 is 3-4 mm. In this embodiment, the internal diameter of the hollow metallic pipe 202 is 3 mm. The wire diameter of the heating wire 203 is 2 mm. The heating wire 203 is movably installed in the hollow metallic pipe 202, which is convenient for installation and replacement.

According to the electrically heated toilet seat of this embodiment, the bottom of the toilet seat is formed with an inner engaging trough 1003, an outer engaging trough 1001, and a raised portion between the inner engaging trough 1003 and the outer engaging trough 1001. The toilet seat 100 is composed of a toilet seat main body 110 and an installation lid 120. Joint surfaces of both are provided with a recessed configuration, respectively. The toilet seat main body 110 is formed with an installation recess 1002. The installation lid 120 is formed with a retaining recess 1012. The bottom of the toilet seat 100 is formed with an inner engaging trough 1003, an outer engaging trough 1001, and a raised portion between the inner engaging trough 1003 and the outer engaging trough 1001. The installation lid 120 is disposed on the raised portion. When the installation lid 120 and the toilet seat main body 110 are joined together, the heat conduction device is enclosed in the raised portion. The bottom of the toilet seat 100 is provided with the inner engaging trough 1003 and the outer engaging trough 1001 to engage with the inner edge and the outer edge of the toilet base when in use. The heat conduction device is located in the raised portion between the inner engaging trough 1003 and the outer engaging trough 1001, which is better to control the heating position at the middle portion of the toilet seat 100 so as to prevent a partial portion of the toilet seat 100 from being overheated and to enhance the comfort for use. In preparation, the mold to form the toilet seat 100 has a counter configuration relative to the toilet seat 100, such that the toilet seat 100 of the aforesaid structure can be manufactured.

The method for manufacturing the electrically heated toilet seat of this embodiment is described as follows:

Step 1) preparing a heat conduction device: an annular metallic baseplate 201 is formed by punching a metallic plate having a thickness of 2 mm according to the shape of the toilet seat, and the width of the metallic baseplate 201 is about 1 cm. During production, the size of the metallic baseplate 201 substantially corresponds to the shape of the electrically heated toilet seat 100. Preferably, the metallic baseplate 201 can be disposed in the middle the toilet seat 100. In the first embodiment, the rear end of the toilet seat 100 is disconnected because it is not necessary to heat the rear end of the toilet seat 100, so that there is no waste of heat energy and the material can be saved. A hollow metallic pipe 202 is manufactured corresponding in shape to the metallic baseplate 201 and welded on the metallic baseplate 201. Two ends of the hollow metallic pipe 202 extend out of the metallic baseplate 201 to form exposed end portions 2021. The diameter of the metallic pipe of the heat conduction device is about 3 mm. In this embodiment, the metallic material is selected from steel.

Step 2) preparing a toilet seat main body 110: the toilet seat main body 110 having an installation recess 1002 is formed by thermal molding; in accordance with the configuration of the toilet seat main body 110 to get a mold, and then using the mold to form the toilet seat main body 110 by injection molding.

Step 3) preparing an installation lid 120: the installation lid 120 having a retaining recess 1012 is formed by thermal molding; in accordance with the configuration of the installation lid 120 to get a mold, and then using the mold to form the installation lid 120 by injection molding.

It is necessary to explain that the molds are manufactured according to the shape and size of the toilet seat 100 and the configuration of the heat conduction device. The toilet seat main body 110 and the installation lid 120 manufactured by these two molds are connected together to become an integral toilet seat 100.

Step 4) installing the heat conduction device: the heat conduction device in step 1) is placed in the installation recess 1002 of the toilet seat main body 110, and the installation lid 120 is to cover the installation recess 1002 of the toilet seat main body 110, and the retaining recess 1012 is aligned with the installation recess 1002 so as to enclose the heat conduction device. The toilet seat main body 110 and the installation lid 120 are fixed through screws to become an integral toilet seat 110 having the heat conduction device.

Preferably, the installation of the heat conduction device is described hereinafter. After the heat conduction device is placed into the installation recess 1002, a stuffing is provided and filled between the heat conduction device and the side wall of the installation recess 1002. When the installation lid 120 is to cover the heat conduction device, a soft spacer 130 is provided between the joint surfaces of the installation lid 120 and the toilet seat main body 110 and another soft spacer 130 is provided inside the retaining recess 1012. When the heat conduction device is installed, the stuffing and the soft spacers 130 are added. On the one hand, it is convenient to retain the heat conduction device so that the interior of the toilet seat won't shake, on the other hand, the heat from the heat conduction device can be transmitted to the toilet seat main body 110 more easily through the stuffing. The airtightness of the junction of the installation lid 120 and the toilet seat main body 110 can be enhanced due to the soft spacers 130, such that the toilet seat has a longer service life and can be used more comfortably.

Step 5) installing a heating wire: the heating wire 203 is installed into the hollow metallic pipe 202 and connected with a power junction box. The wire diameter of the heating wire 203 is 2 mm which is less than the internal diameter of the hollow metallic pipe 202 so as to be inserted conveniently. The voltage provided by the power junction box is 24V. In order to improve the comfort of use, the power junction box of this embodiment is provided with a temperature control unit. In order to improve the comfort of use, the power switch can be any one of a light-operated switch, a voice-operated switch and a pressure switch. In this embodiment, the power switch is a pressure switch, namely, it is switched on or off through the pressure sensed from the toilet seat. When the user sits on the toilet seat, the power is switched on. When the user leaves the toilet seat, the power is switched off. This can be more energy-saving.

When the user sits on the toilet seat, the front end of the toilet seat is not in contact with the user. Therefore, it is meaningless to heat the front end of the toilet seat. The front ends of some toilet seats are disconnected to form a U shape. For this condition, the present invention provides another embodiment, namely, the heat conduction device is a disconnected configuration corresponding to the front end of the toilet seat.

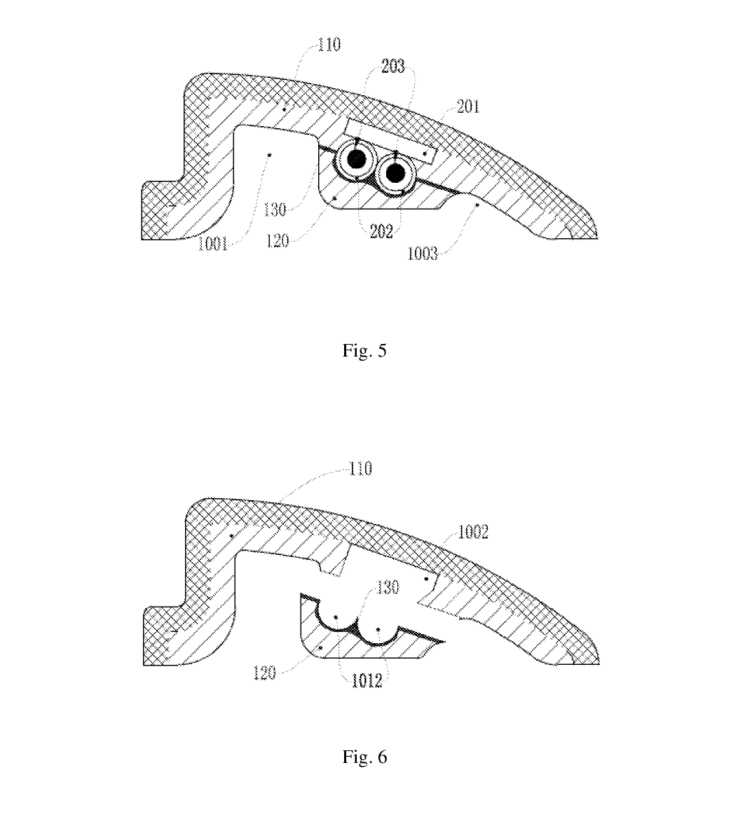

As shown in FIG. 4 through FIG. 6, an electrically heated toilet seat according to a second embodiment of the present invention comprises a toilet seat 100 and a heat conduction device disposed in the toilet seat 100. The heat conduction device has a hollow configuration. The hollow configuration is provided with a detachable heating wire 203 therein. The heating wire 203 is connected with a power junction box (not shown in the drawings). The heat conduction device comprises a metallic baseplate 201 and a hollow metallic pipe 202 fixed to the metallic baseplate 201. The heating wire 203 is disposed in the hollow metallic pipe 202. The hollow metallic pipe 202 is located under the metallic baseplate 201. The heating wire 203 is guided out form one end of the hollow metallic pipe 202. The heat conduction device is disconnected at the front end of the toilet seat to be separated into two portions. The hollow metallic pipe 202 of each portion has a U shape. The heating wire 203 in the hollow metallic pipe 202 of each portion is connected with the power junction box to form a separate circuit. The manufacturing method of the second embodiment is substantially similar to that of the first embodiment, so it won't be described hereinafter.

In the embodiments of the present invention, there are many ways to connect the hollow metallic pipe and the metallic baseplate. In general, they can be connected by welding or bonding, or the metallic baseplate is provided with an engaging groove and the hollow metallic pipe is engaged with the engaging groove.

In the embodiments of the present invention, the power junction box can be disposed externally or installed at the bottom of the toilet seat. For the power junction box installed at the bottom of the toilet seat, it can be sealed to prevent a breakdown caused by water. Only a guide wire is guided out to connect with an external power source. The voltage provided by the power junction box is generally below 36V. In general, the voltage is 12V and 24V.

In the embodiments of the present invention, the heating wire can be inserted into the hollow metallic pipe before injection molding for the manufacturing method of the heated toilet seat.

The heat conduction device can be a hollow metallic pipe as shown in an embodiment of the present invention. However, it is not easy to position the single hollow metallic pipe, and its heating effect is not better than that of the hollow metallic pipe fixed to the metallic baseplate.

Injection molding is one of thermal moldings. The toilet seat of the present invention can be formed by other thermal moldings, such as hot compression molding. The material is not limited to plastics. Any material applied to thermal molding can be used, such as resin or rubber.

The toilet seat of the present invention can be heated quickly and evenly. The heating wire can be replaced quickly and conveniently for maintenance. Its manufacturing method is convenient for fixing the heat conduction device. The heat conduction device can be fixed at the middle of the toilet seat well and enclosed by the plastics of the toilet seat well to heat the toilet seat evenly.

Although particular embodiments of the present invention have been described in detail for purposes of illustration, various modifications and enhancements may be made without departing from the spirit and scope of the present invention. Accordingly, the present invention is not to be limited except as by the appended claims.

1. An electrically heated toilet seat, comprising a toilet seat and a heat conduction device disposed in the toilet seat; the toilet seat being composed of a toilet seat main body and an installation lid, at least one of the toilet seat main body and the installation lid being provided with a recessed configuration corresponding to the heat conduction device, the toilet seat main body and the installation lid being joined together to enclose the heat conduction device inside the toilet seat; the heat conduction device having a hollow configuration, the hollow configuration being provided with a detachable heating wire therein; the heating wire being connected with a power junction box.

2. The electrically heated toilet seat as claimed in claim 1, wherein the heat conduction device comprises a hollow metallic pipe or is composed of a metallic baseplate and the hollow metallic pipe fixed to the metallic baseplate, and the heating wire is disposed in the hollow metallic pipe.

3. The electrically heated toilet seat as claimed in claim 2, wherein the hollow metallic pipe is located under the metallic baseplate, and the heating wire is guided out from one end of the hollow metallic pipe.

4. The electrically heated toilet seat as claimed in claims 1, wherein a bottom of the toilet seat is formed with an inner engaging trough, an outer engaging trough, and a raised portion between the inner engaging trough and the outer engaging trough, the installation lid is disposed on the raised portion, after the installation lid and the toilet seat main body are joined together, the heat conduction device is enclosed in the raised portion.

5. The electrically heated toilet seat as claimed in claim 4, wherein a soft spacer is provided between the installation lid and the heat conduction device, and another soft spacer is provided between joint surfaces of the installation lid and the toilet seat main body.

6. The electrically heated toilet seat as claimed in claim 3, wherein the heat conduction device is disconnected at a front end of the toilet seat to be separated into two portions, the hollow metallic pipe of each portion has a U shape, and the heating wire in the hollow metallic pipe of each portion is connected with the power junction box to form a separate circuit.

7. The electrically heated toilet seat as claimed in claim 2, wherein the heat conduction device comprises two hollow metallic pipes, each of the two hollow metallic pipes is provided with the heating wire, the heating wire of each of the two hollow metallic pipes forms a closed circuit alone, the heating wires of the two hollow metallic pipes have different heating powers.

8. A method for manufacturing an electrically heated toilet seat, comprising:
1) preparing a heat conduction device: a metallic baseplate prefabricated according to the size of the electrically heated toilet seat being fixedly connected with a hollow metallic pipe to manufacture the heat conduction device;
2) preparing a toilet seat main body: the toilet seat main body having an installation recess being formed by thermal molding;
3) preparing an installation lid: the installation lid having a retaining recess being formed by thermal molding;
4) installing the heat conduction device: the heat conduction device in 1) being placed in the installation recess of the toilet seat main body, the installation lid being to cover the installation recess of the toilet seat main body, the retaining recess being aligned with the installation recess so as to enclose the heat conduction device, the toilet seat main body and the installation lid being fixed by means of a screw, plastic ultrasonic welding, or a buckle to become an integral toilet seat; and
5) installing a heating wire: the heating wire being installed into the hollow metallic pipe, and the heating wire being guided out from one end of the hollow metallic pipe to connect with a power junction box.

9. The method for manufacturing an electrically heated toilet seat as claimed in claim 8, wherein 2) and 3) can be changed in sequence.

10. The method for manufacturing an electrically heated toilet seat as claimed in claim 8, wherein in 4) after the heat conduction device is placed into the installation recess, a stuffing is provided and filled between the heat conduction device and a side wall of the installation recess; when the installation lid is to cover the heat conduction device, a soft spacer is provided between joint surfaces of the installation lid and the toilet seat main body and another soft spacer is provided inside the retaining recess.
